(19) United States
(12) Patent Application Publication
(10) Pub. No.: US 2017/0371510 A1
(43) Pub. Date: Dec. 28, 2017

(54) INFORMATION PROCESSING APPARATUS, INFORMATION PROCESSING SYSTEM, AND IMAGE FORMING APPARATUS

(71) Applicant: FUJI XEROX CO., LTD., Tokyo (JP)

(72) Inventor: Mayumi MAKIYAMA, Kanagawa (JP)

(73) Assignee: FUJI XEROX CO., LTD., Tokyo (JP)

(21) Appl. No.: 15/346,118

(22) Filed: Nov. 8, 2016

(30) Foreign Application Priority Data
Jun. 28, 2016 (JP) 2016-127754

(51) Int. Cl. G06F 3/0485; G06F 3/01; H04N 1/00; G06F 3/03

(52) U.S. Cl. CPC G06F 3/0485; H04N 1/00411; G06F 3/013; H04N 1/00458; G06F 3/0304; H04N 2201/0094

(57) ABSTRACT

An information processing apparatus includes a display, an operating unit, and a movement controller. The display displays in a form of a display image a portion of information including plural items and moves the display image at a first speed by scrolling so as to display the plural items in a predetermined order. The operating unit accepts a movement instruction operation from a user for moving the display image. The movement controller performs control for reducing a movement speed to a speed lower than the first speed when a line of sight of the user toward the display image changes while the movement controller causes the display image to move.

### CROSS-REFERENCE TO RELATED APPLICATIONS

This application is based on and claims priority under 35 USC 119 from Japanese Patent Application No. 2016-127754 filed Jun. 28, 2016.

### BACKGROUND

### (i) Technical Field

The present invention relates to an information processing apparatus, an information processing system, and an image forming apparatus.

### (ii) Related Art

In some cases, information such as a recipient list or the like is displayed in the form of a display image in a display of an information processing apparatuses. When the display image of the information does not fit in the display, the information is typically viewed in the following method: a portion of the display image is displayed in the display, and the user scrolls the displayed display image.

### SUMMARY

According to an aspect of the present invention, an information processing apparatus includes a display, an operating unit, and a movement controller. The display displays in a form of a display image a portion of information including plural items and moves the display image at a first speed by scrolling so as to display the plural items in a predetermined order. The operating unit accepts a movement instruction operation from a user for moving the display image. The movement controller performs control for reducing a movement speed to a speed lower than the first speed when a line of sight of the user toward the display image changes while the movement controller causes the display image to move.

### BRIEF DESCRIPTION OF THE DRAWINGS

Exemplary embodiment of the present invention will be described in detail based on the following figures, wherein:

FIG. 1 illustrates an information processing system according to an exemplary embodiment;

FIG. 2 is the appearance of an image forming apparatus according to the present exemplary embodiment;

FIG. 3 illustrates an internal structure of the image forming apparatus according to the present exemplary embodiment;

FIG. 4 is an example of a display image displayed in the user interface;

FIG. 5 is a block diagram illustrating an example of a functional configuration of a control device;

FIG. 6 is a flowchart illustrating a first example of operations of the control device;

FIGS. 7A to 7D illustrate examples of display images displayed in the user interface;

FIG. 8 is a flowchart illustrating a second example of the operations of the control device; and

FIGS. 9A and 9B illustrate examples of display images displayed in the user interface.

### DETAILED DESCRIPTION

An exemplary embodiment will be described in detail below with reference to the accompanying drawings.

### Description of an Overall Structure of an Information Processing System

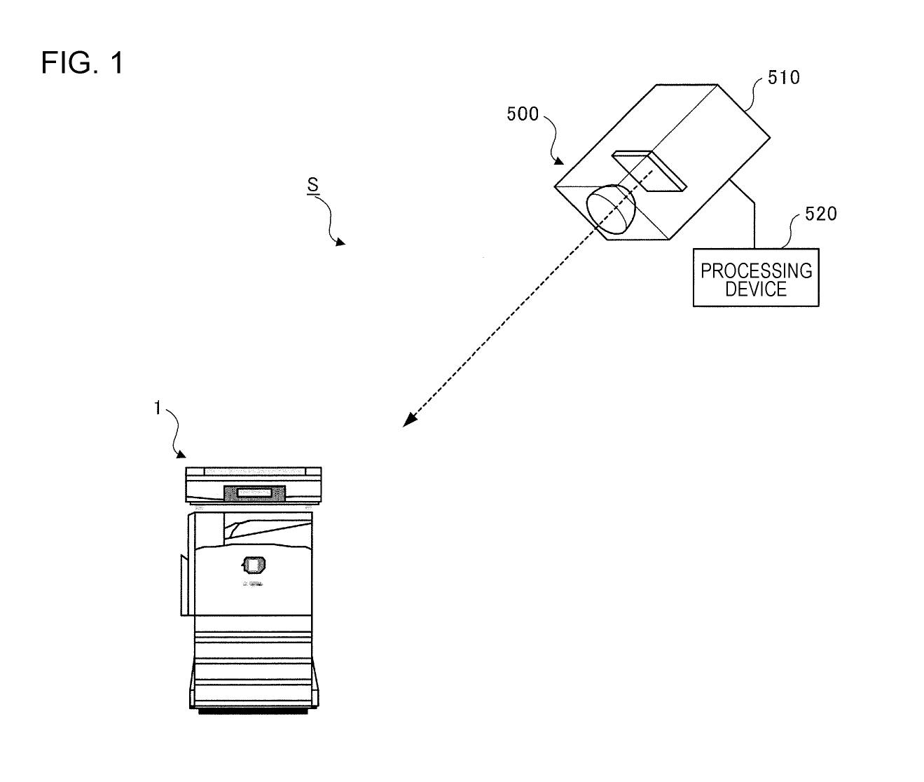

FIG. 1 illustrates an information processing system according to an exemplary embodiment.

As illustrated in FIG. 1, an information processing system S includes a detection device 500 and an image forming apparatus (information processing apparatus) 1. The detection device 500 serves as an example of a detector that detects a line of sight of a user. The image forming apparatus 1 forms an image on a recording material.

### Description of the Detection Device 500

The detection device 500 includes a camera 510 and a processing device 520. The camera 510 is used to take an image of the user. The processing device 520 obtains the line of sight of the user in accordance with the image taken by the camera 510.

The camera 510 includes, for example, an optical system and an image sensor. The optical system converges light incident thereupon. The image sensor is an imaging device that detects the light having been converged by the optical system.

The optical system includes a single lens or plural lenses combined with one another. Various types of aberrations are eliminated by a combination of the lenses, coatings provided on the surfaces of the lenses, and so forth. The image sensor includes imaging elements such as charge coupled devices (CCDs) or complementary metal oxide semiconductors (CMOSs) arranged therein.

The processing device 520 analyzes the image taken by the camera 510 and detects the line of sight of the user in accordance with the analysis of the image. Here, the line of sight of the user refers to, for example, information about what is a target watched by the user, and furthermore, includes, for example, information about the size of the pupil, information about whether or not the user intensely watches the target, and so forth.

The processing device 520 extracts, for example, parts of the user such as the face and the eye from the image taken by the camera 510 and detects the line of sight of the user in accordance with the orientation of the face, the position of the pupil in the eye, and the like.

### Description of an Overall Structure of the Image Forming Apparatus 1

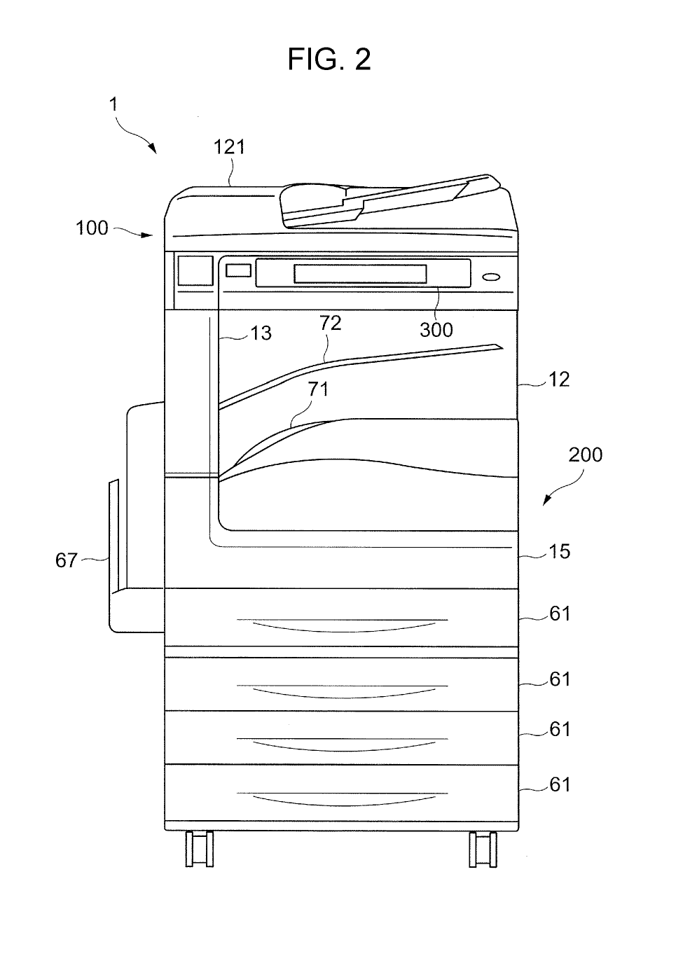

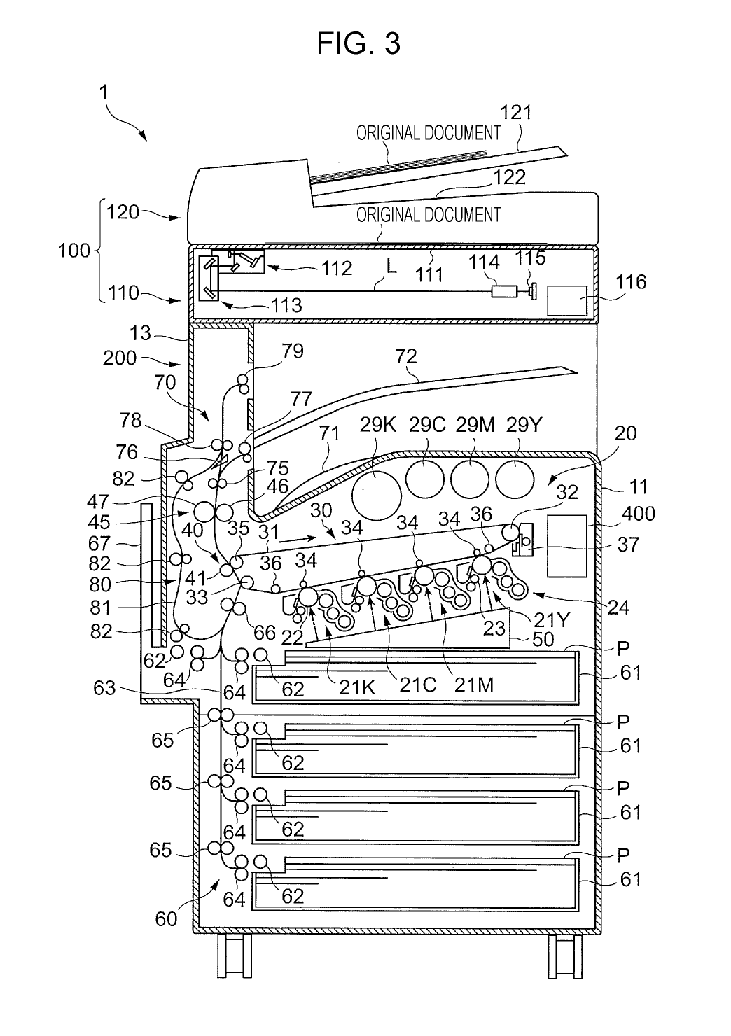

FIG. 2 is the appearance of the image forming apparatus 1 according to the present exemplary embodiment. FIG. 3 is an internal structure of the image forming apparatus 1 according to the present exemplary embodiment.

The image forming apparatus 1 includes an image reading device 100 that reads an image on an original document and an image recording device 200 that records the image on the recording material (“recording material” is also representatively referred to as “sheet P” hereafter. Also, “sheet P” is described in the plural form “sheets P” where appropriate). Furthermore, the image forming apparatus 1 includes a user interface (UI) 300 that accepts operating input performed by the user and displays various types of information for the user. Furthermore, the image forming apparatus 1 includes a control device 400 that controls operations of the entirety of the image forming apparatus 1.

The image reading device 100 is disposed on an upper portion of the image forming apparatus 1. The image recording device 200 is disposed below the image reading device 100. The control device 400 is disposed in the image recording device 200. The user interface 300 is disposed in an upper central portion on the front side of the image processing apparatus 1, that is, on the front side of a central portion of an image reading unit 110, which will be described later, of the image reading device 100.

First, the image reading device 100 is described.

The image reading device 100 includes the image reading unit 110 that reads the image of the original document and a document transport unit 120 that transports the original document to the image reading unit 110. The document transport unit 120 is disposed in an upper portion of the image reading device 100. The image reading unit 110 is disposed in a lower portion the image reading device 100.

The document transport unit 120 includes a document loader 121 and a document output unit 122. The document loader 121 contains the original document. The original document transported from the document loader 121 is output to the document output unit 122. Thus, the original document is transported from the document loader 121 to the document output unit 122. The document transport unit 120 is also referred to as an auto document feeder (ADF).

The image reading unit 110 includes a platen glass 111, a light radiation unit 112, a light guide unit 113, and an imaging lens 114. The light radiation unit 112 radiates light toward a target side (image side) of the original document. The light guide unit 113 guides light L radiated by the light radiation unit 112 toward the target side of the original document and reflected at the target side of the original document. The imaging lens 114 focuses an optical image of the light L guided by the light guide unit 113. Furthermore, the image reading unit 110 includes a detection unit 115 and an image processing unit 116. The detection unit 115 includes a photoelectric converter such as a CCD image sensor that photoelectrically converts the light L having been focused by the imaging lens 114, so that the detection unit 115 detects the focused optical image. The image processing unit 116 is electrically connected to the detection unit 115, so that an electric signal as image information obtained by the detection unit 115 is transmitted to the image processing unit 116.

The image reading unit 110 reads an image of the original document transported by the document transport unit 120 and an image of the original document placed on the platen glass 111.

Next, the image recording device 200 is described.

The image recording device 200 includes an image forming section 20, a sheet feed unit 60, a sheet output unit 70, and an inversion transport unit 80. The image forming section 20 forms an image on the sheet P. The sheet feed unit 60 feeds the sheet P to the image forming section 20. The sheet output unit 70 outputs the sheet P on which the image has been formed by the image forming section 20. The inversion transport unit 80 inverts the sheet P on one side of which the image has been formed by the image forming section 20 while transporting again the sheet P toward the image forming section 20.

The image forming section 20 includes four image forming units 21Y, 21M, 21C, and 21K for yellow (Y), magenta (M), cyan (C), and black (K). The image forming units 21Y, 21M, 21C, and 21K are arranged parallel to one another and spaced from one another with a certain distance set therebetween. The image forming units 21 include respective photosensitive drums 22, respective chargers 23, and respective developing devices 24. The chargers 23 uniformly charge the surfaces of the respective photosensitive drums 22. The developing devices 24 each develop an electrostatic latent image formed by laser radiation performed by an optical system unit 50, which will be described later, with toner of a corresponding one of predetermined color components so as to make visible the electrostatic latent image. Furthermore, the image forming section 20 is provided with toner cartridges 29Y, 29M, 29C, and 29K that supply toner of the colors to the developing devices 24 of the respective image forming units 21Y, 21M, 21C, and 21K.

The image forming section 20 includes the optical system unit 50 below the image forming units 21Y, 21M, 21C, and 21K. The optical system unit 50 radiates laser light toward the photosensitive drums 22 of the image forming units 21Y, 21M, 21C, and 21K. The optical system unit 50 includes a semiconductor laser (not illustrated) and a modulator (not illustrated). The optical system unit 50 also includes a polygon mirror (not illustrated), a window (not illustrated) and a frame (not illustrated). The polygon mirror deflects and scans the laser light emitted from the semiconductor laser. The window formed of glass allows the laser light to pass therethrough. The frame tightly encloses the elements of the optical system unit 50.

Furthermore, the image forming section 20 includes an intermediate transfer unit 30, a second transfer unit 40, and a fixing device 45. The intermediate transfer unit 30 performs multi-transfer, through which the toner images of the colors formed on the photosensitive drums 22 of the image forming units 21Y, 21M, 21C, and 21K are transferred onto an intermediate transfer belt 31. The second transfer unit 40 transfers the toner images superposed on the intermediate transfer unit 30 onto the sheet P. The fixing device 45 fixes the toner images formed on the sheet P by applying heat and pressure.

The intermediate transfer unit 30 includes the intermediate transfer belt 31, a drive roller 32, and a tension roller 33. The drive roller 32 drives the intermediate transfer belt 31. The tension roller 33 applies a certain amount of, tension to the intermediate transfer belt 31. The intermediate transfer unit 30 also includes first transfer rollers 34 and a backup roller 35. Two or more (four according to the present exemplary embodiment) of the first transfer rollers 34 face the photosensitive drums 22 with the intermediate transfer belt 31 interposed therebetween and transfers the toner images formed on the photosensitive drums 22 onto the intermediate transfer belt 31. The backup roller 35 faces a second transfer roller 41, which will be described later, with the intermediate transfer belt 31 interposed therebetween.

The intermediate transfer belt 31 is looped over plural rotating members including, for example, the drive roller 32, the tension roller 33, the first transfer rollers 34, the backup roller 35, and a driven rollers 36. The intermediate transfer belt 31 is rotated in an arrow direction at a predetermined speed by the drive roller 32 rotated by a drive motor (not illustrated). The intermediate transfer belt 31 is formed of, for example, rubber or resin.

The intermediate transfer unit 30 also includes a cleaner 37 that removes residual toner and the like existing on the intermediate transfer belt 31. The cleaner 37 removes the residual toner, paper dust, and the like from the surface of the intermediate transfer belt 31 after the toner images have been transferred.

The second transfer unit 40 includes the second transfer roller 41 provided at a second transfer position. The second transfer roller 41 is pressed against the backup roller 35 with the intermediate transfer belt 31 interposed therebetween so as to transfer the images onto the sheet P through second transfer. The second transfer position is formed by the second transfer roller 41 and the backup roller 35 that faces the second transfer roller 41 with the intermediate transfer belt 31 interposed therebetween. At the second transfer position, the toner images having been transferred onto the intermediate transfer belt 31 are transferred onto the sheet P.

The fixing device 45 fixes onto the sheet P the images (toner images) having been transferred onto the sheet P through the second transfer performed by the intermediate transfer unit 30. This fixing of the images is performed by utilizing heat and pressure with a heating fixing roller 46 and a pressure roller 47.

The sheet feed unit 60 includes sheet containers 61, feed rollers 62, a transport path 63, and transport rollers 64, 65, and 66. The sheet containers 61 contain the sheets P on which images are to be formed. The feed rollers 62 feed sheets P contained in the sheet containers 61. The sheets P fed by the feed rollers 62 are transported through the transport path 63. The transport rollers 64, 65, and 66 are disposed along the transport path 63 so as to transport the sheets P fed by the feed rollers 62 to the second transfer position. The sheet feed unit 60 also includes a manual feed tray 67 that allows the sheets to be manually fed. The manual feed tray 67 is openable. Thus, the manual feed tray 67 is opened when in use so as to allow the sheets P to be set therein and closed when not in use. FIG. 3 illustrates the manual feed tray 67 in a closed state.

The sheet output unit 70 includes a first placement tray 71 and a second placement tray 72. The first placement tray 71 is provided above the image forming section 20 and allows the sheets P on which the images have been formed by the image forming section 20 to be placed therein. The second placement tray 72 is provided between the first placement tray 71 and the image reading device 100 and allows the sheets P on which the images have been formed by the image forming section 20 to be placed therein.

The sheet output unit 70 also includes a transport roller 75 and a switching gate 76. The transport roller 75 is provided downstream of the fixing device 45 in a transport direction so as to transport each of the sheets P onto which the toner images have been fixed. The switching gate 76 is provided downstream of the transport roller 75 in the transport direction and switches the transport direction of the sheet P. The sheet output unit 70 also includes a first output roller 77 disposed downstream of the switching gate 76 in the transport direction. The first output roller 77 outputs to the first placement tray 71 the sheet P transported in the transport direction switched to one side (right side of FIG. 3) by the switching gate 76. The sheet output unit 70 also includes a transport roller 78 and a second output roller 79 disposed downstream of the switching gate 76 in the transport direction. The transport roller 78 transports the sheet P transported in the transport direction switched to the other side (upper side of FIG. 3) by the switching gate 76. The second output roller 79 outputs the sheet P transported by the transport roller 78 to the second placement tray 72.

The inversion transport unit 80 includes an inversion transport path 81 beside the fixing device 45. The sheet P is inverted by rotating the transport roller 78 in the opposite direction to the direction in which the transport roller 78 outputs the sheet P to the second placement tray 72 and being transported through the inversion transport path 81. Plural transport rollers 82 are provided along the inversion transport path 81. The sheet P transported by these transport rollers 82 are fed to the second transfer position again by the transport rollers 82.

Furthermore, the image recording device 200 includes a device-body frame 11 and a device housing 12. The device-body frame 11 directly or indirectly supports the image forming section 20, the sheet feed unit 60, the sheet output unit 70, the inversion transport unit 80, and the control device 400. The device housing 12 is attached to the device-body frame 11 so as to form the outer surface of the image forming apparatus 1.

The device-body frame 11 includes a reading-device support 13 on one lateral end side of the image forming apparatus 1. The components such as the switching gate 76, the first output roller 77, the transport roller 78, and the second output roller 79 are disposed in the reading-device support 13. The reading-device support 13 extends in the up-down direction so as to support the image reading device 100. The reading-device support 13 cooperates with a portion of the device-body frame 11 on the rear side for supporting the image reading device 100.

Furthermore, the image recording device 200 includes a front covering 15 as part of the device housing 12. The front covering 15 is provided on the front side of the image forming section 20 and openably attached to the device-body frame 11.

The user is able to replace any of the intermediate transfer unit 30 and the toner cartridges 29Y, 29M, 29C, and 29K of the image forming section 20 with a new one by opening the front covering 15.

The user interface 300 is, for example, a touch panel. With the touch panel used as the user interface 300, various types of information such as image forming conditions of the image forming apparatus 1 are displayed in the touch panel. The user performs input operations for the image forming conditions and so forth by touching the touch panel. That is, the user interface 300 functions as a display that displays information relating to the image forming apparatus 1 in which the user interface 300 is included and also functions as an operating unit that accepts an operation performed by the user. The user interface 300 is not necessarily a touch panel. The functions of the display and the functions of the operating unit may be separated. That is, the user interface 300 may include a display and an operating unit separated from each other. In this case, the display includes a liquid crystal display or the like so as to display information relating to the image forming apparatus 1, and the operating unit includes physical buttons or the like so as to accept the operation performed by the user.

### Description of the Operations of the Image Forming Apparatus 1

The image forming apparatus 1 having the above-described structure operates as follows.

For example, the user is able to copy an original document by using the image forming apparatus 1. That is, the original document is able to be copied by forming an image on the sheet P with the image recording device 200 in accordance with image data of the original document read by the image reading device 100. Furthermore, the user is able to perform printing by transmitting a print job to the image forming apparatus 1 from a personal computer (PC) or the like (not illustrated) connected to a line of communication. That is, the printing is able to be performed by receiving the print job through the line of communication and forming an image on the sheet P with the image recording device 200 in accordance with image data included in the print job. Furthermore, facsimile communication is usable for the user. That is, image data of an original document read by the image reading device 100 is able to be transmitted through the line of communication. The user is also able to save image data of an original document. That is, the image data of the original document is able to be saved in the image forming apparatus 1 or a PC connected to the line of communication.

Here, operations of the image forming apparatus 1 are described in detail with an example in which the user copies an original or performs printing.

An image of the original document read by the image reading device 100 and image data received from the PC or the like are subjected to predetermined image processing. The image data on which the image processing has been performed is converted into colorant gradation data of the four colors, that is, yellow (Y), magenta (M), cyan (C), and black (K) and output to the optical system unit 50.

In the optical unit 50, the laser light emitted from the semiconductor laser (not illustrated) in accordance with the received color gradation data is directed to the polygon mirror through an f-O lens (not illustrated). With the polygon mirror, the laser light incident thereupon is modulated in accordance with the gradation data of the colors, deflected and scanned, and radiated to the photosensitive drums 22 of the image forming units 21Y, 21M, 21C, and 21K through an imaging lens (not illustrated) and plural mirrors (not illustrated).

The surfaces of the photosensitive drums 22 of the image forming units 21Y, 21M, 21C, and 21K having been charged by the chargers 23 are exposed to and scanned by the laser light, thereby electrostatic latent images are formed. The electrostatic latent images having been formed are developed into toner images of yellow (Y), magenta (M), cyan (C), and black (K) colors by the respective image forming units 21Y, 21M, 21C, and 21K. The toner images formed on the photosensitive drums 22 of the image forming units 21Y, 21M, 21C, and 21K are transferred onto the intermediate transfer belt 31 serving as an intermediate transfer body through multi-transfer.

Meanwhile, in the sheet feed unit 60, the sheet P contained in one of the sheet containers 61 is picked up by rotating a corresponding one of the feed rollers 62 at timing adjusted to timing of image formation. The picked up sheet P is transported through the transport path 63 by the transport rollers 64 and 65. After that, the transport roller 66 is rotated at timing adjusted to movement timing of the intermediate transfer belt 31 on which the toner images have been formed, thereby transporting the sheet P to the second transfer position formed by the backup roller 35 and the second transfer roller 41. At the second transfer position, the toner images of four colors superposed on one another are transferred in the sub-scanning direction by using a pressure contact force and a predetermined electric field onto the sheet P being transported upward from below. The sheet P onto which the toner images of the colors have been transferred is subjected to a fixing process of heat and pressure performed by the fixing device 45 and then output and placed in the first placement tray 71 or the second placement tray 72.

When duplex printing is requested, the sheet P on one side of which the images have been formed is transported by the inversion transport unit 80 so as to be inverted, and the sheet P is fed again to the second transfer position. At the second transfer position, the toner images are transferred onto the other side of the sheet P, and the transferred images are fixed by the fixing device 45. After that, the sheet P on both the sides of which the toner images have been formed is output and placed in the first placement tray 71 or the second placement tray 72.

The user interface 300 operates as follows.

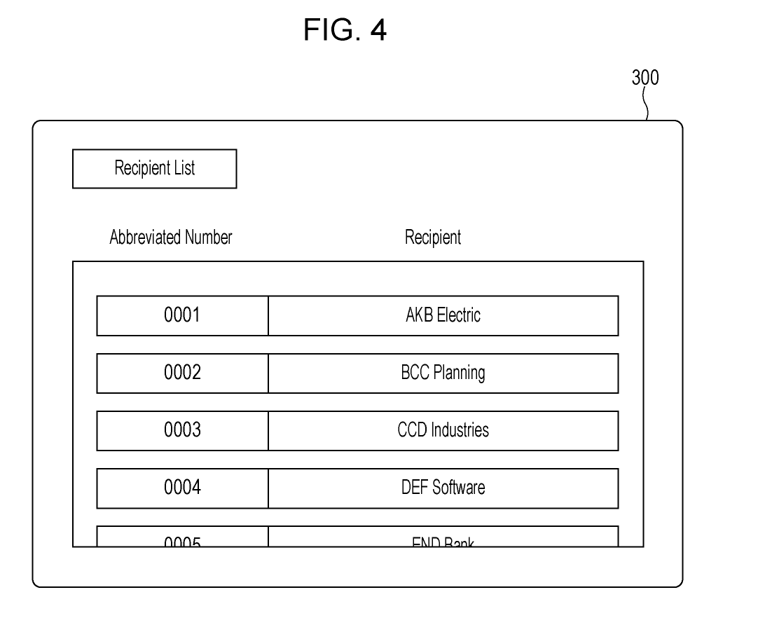

FIG. 4 is an example of a display image displayed in the user interface 300.

As has been described, information displayed in the user interface 300 is information relating to the image forming apparatus 1 in which the user interface 300 is included. Specifically, when the user copies an original document or performs a printing operation, image forming conditions such as the size of the sheet P to be used, simplex printing/duplex printing, and so forth are displayed in the user interface 300. When the user performs a facsimile operation, a list that includes abbreviated numbers and names of recipients and so forth of the facsimile is displayed in the user interface 300. Furthermore, when the user saves image data having been read, a list of destinations for saving the image data is displayed in the user interface 300.

In the example of, for example, FIG. 4, a list of recipients of facsimile is displayed as a “Recipient List” in the user interface 300. In this case, the abbreviated number and the name of each of the recipients are combined as a single item, and plural items are arranged in the up-down direction of the user interface 300 of, for example, FIG. 4.

In this state, a portion of information including plural items is displayed as a display image in the user interface 300. That is, when there are many items, it is impossible to display all the items at once in the user interface 300. Accordingly, among all the items, some of the items are displayed and other items are to be displayed in a predetermined order by being moved (transitioned) due to scrolling of the display image. In this case, scrolling is performed in the up-down direction of the user interface 300 of, for example, FIG. 4. The scrolling may be performed by moving the display image by a predetermined number of pixels or by defining the display image displayed at a time as a single page and sequentially changing pages from one page to another page.

The user interface 300 starts the scrolling upon reception of a movement instruction operation from the user for moving the display image.

Specifically, when the user interface 300 is a touch panel, the movement instruction operation is an operation in which the user swipes the touch panel. The movement instruction operation is not limited to this. For example, the movement instruction operation may be, for example, as follows: the user performs an operation such as touching or dragging a scroll bar that is displayed in the touch panel. Furthermore, when the user interface 300 includes a liquid crystal display and physical buttons separated from each other, the movement instruction operation may be an operation in which the user presses down a physical button to which a function of scrolling the display image is assigned.

The user interface 300 stops the scrolling upon reception of a stop instruction operation from the user for stopping the movement of the display image.

Specifically, when the user interface 300 is a touch panel, the stop instruction operation is an operation in which the user touches the touch panel. When the scroll bar is displayed in the touch panel, the stop instruction operation may be as follows: the user moves away from the touch panel his or her finger used to, for example, touch or drag the touch panel. Furthermore, when the user interface 300 includes a liquid crystal display and physical buttons separated from each other, the stop instruction operation may be an operation in which the user moves away his or her finger from a physical button to which a function of scrolling the display image is assigned.

However, when the number of the items further increases, the user may be required to scroll through more pages to reach his or her target item by scrolling. Accordingly, in addition to an increase in time, the user's attention may be distracted, and the user may miss the target item even when the target item is displayed and the user may continue scrolling.

Such a situation may be suppressed by controlling the speed at which the display image displayed in the user interface 300 is scrolled with the control device 400 as follows according to the present exemplary embodiment. Although it will be described in detail later, the control device 400 functions as a movement controller that controls the speed at which the display image is moved by scrolling.

### Description of the Control Device 400

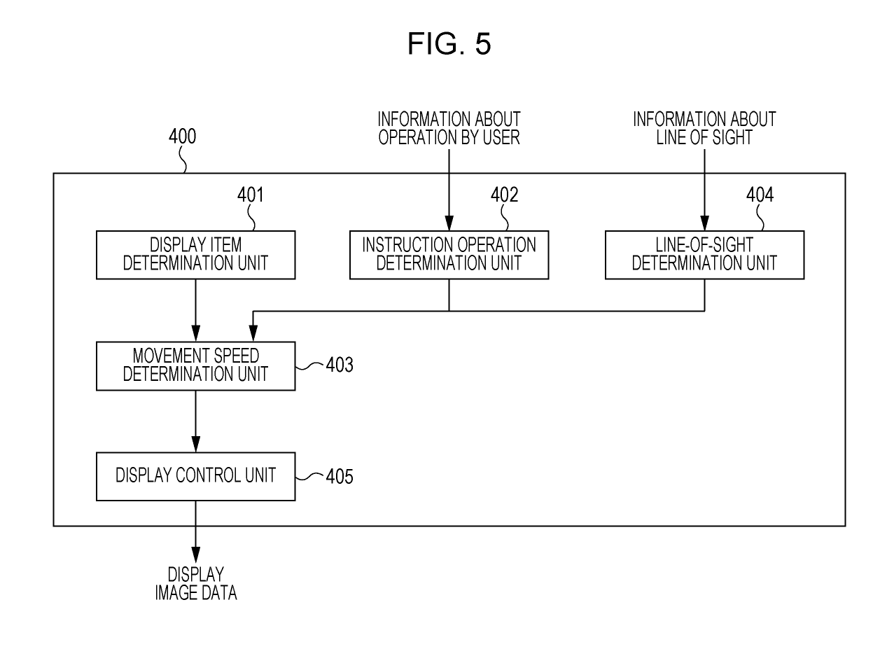

FIG. 5 is a block diagram illustrating an example of a functional configuration of the control device 400. It is noted that, in FIG. 5, functions relating to the present exemplary embodiment are selected and illustrated out of various functions of the control device 400.

As illustrated in FIG. 5, the control device 400 according to the present exemplary embodiment includes a display item determination unit 401, an instruction operation determination unit 402, a movement speed determination unit 403, a line-of-sight determination unit 404, and a display control unit 405. The display item determination unit 401 determines the items to be displayed in the user interface 300. The instruction operation determination unit 402 determines whether or not the movement instruction operation is performed and whether or not the stop instruction operation is performed. The movement speed determination unit 403 determines the movement speed of the scrolling. The line-of-sight determination unit 404 determines the line of sight of the user. The display control unit 405 controls the display image displayed in the user interface 300.

The display item determination unit 401 determines the items to be displayed in the user interface 300 in accordance with the operation of the image forming apparatus 1. Here, a case is described in which the user selects to perform a facsimile operation using the image forming apparatus 1 and the items such as items of FIG. 4 are determined.

The instruction operation determination unit 402 determines whether or not the user inputs the movement instruction operation in accordance with information about the operation performed on the user interface 300 by the user. In this case, the instruction operation determination unit 402 determines, for example, whether or not the user swipes the touch panel. Alternatively, the instruction operation determination unit 402 determines, for example, whether or not the user presses down a physical buttons to which the function to perform scrolling of the display image is assigned.

The instruction operation determination unit 402 also determines whether or not the user inputs the stop instruction operation in accordance with information about the operation performed on the user interface 300 by the user. In this case, the instruction operation determination unit 402 determines, for example, whether or not the user moves away his or her finger from the touch panel. Alternatively, the instruction operation determination unit 402 determines, for example, whether or not the user releases the pressing down of the physical button to which the function to perform scrolling of the display image is assigned.

The movement speed determination unit 403 determines the scrolling speed when the plural items are moved by scrolling in the user interface 300.

The line-of-sight determination unit 404 obtains information about the line of sight of the user detected by the detection device 500 (see FIG. 1). Thus, the line-of-sight determination unit 404 determines what position is watched by the user.

The display control unit 405 performs control for displaying in the user interface 300 the items determined by the display item determination unit 401. Furthermore, if the user inputs the movement instruction operation, the display control unit 405 performs control for scrolling the display image at the speed determined by the movement speed determination unit 403. If the user input the stop instruction operation, the display control unit 405 performs control for stopping the scrolling of the display image. Actually, the display control unit 405 generates at a predetermined time interval display image data of the display image to be displayed in the user interface 300 and sequentially outputs the display image data to the user interface 300.

### Description of Operations of the Control Device 400 First Example

Next, a first example of operations of the control device 400 is described.

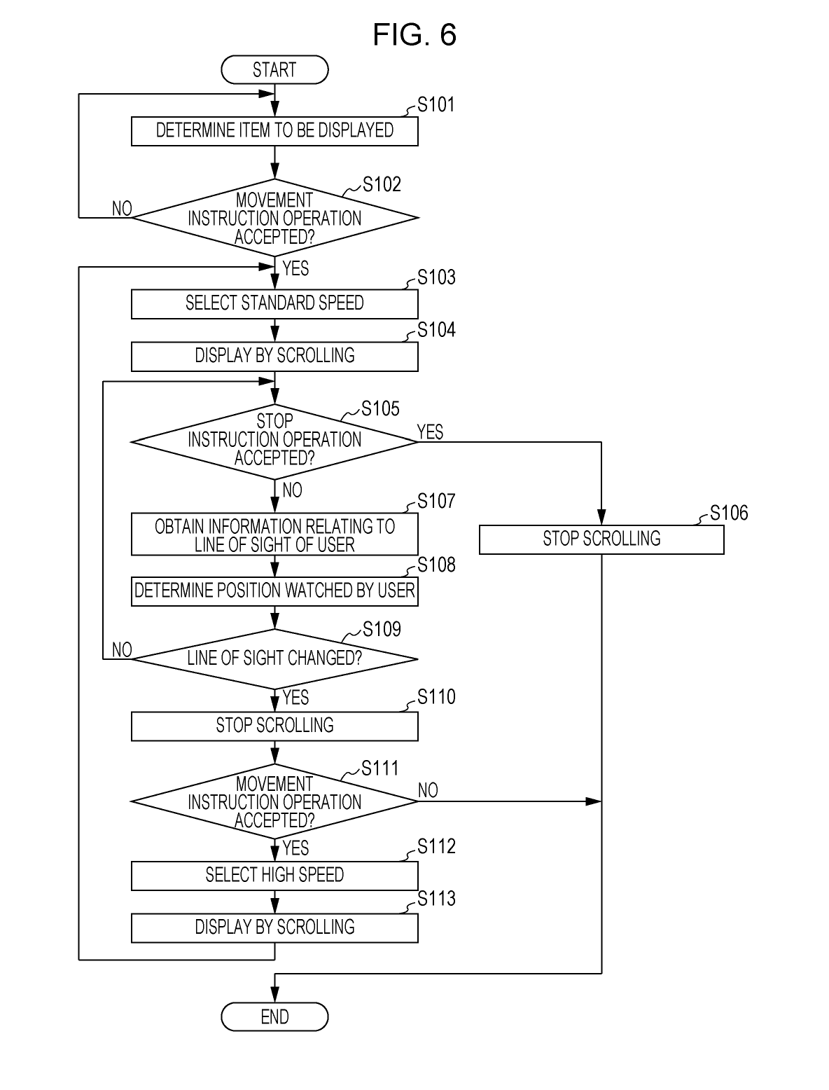

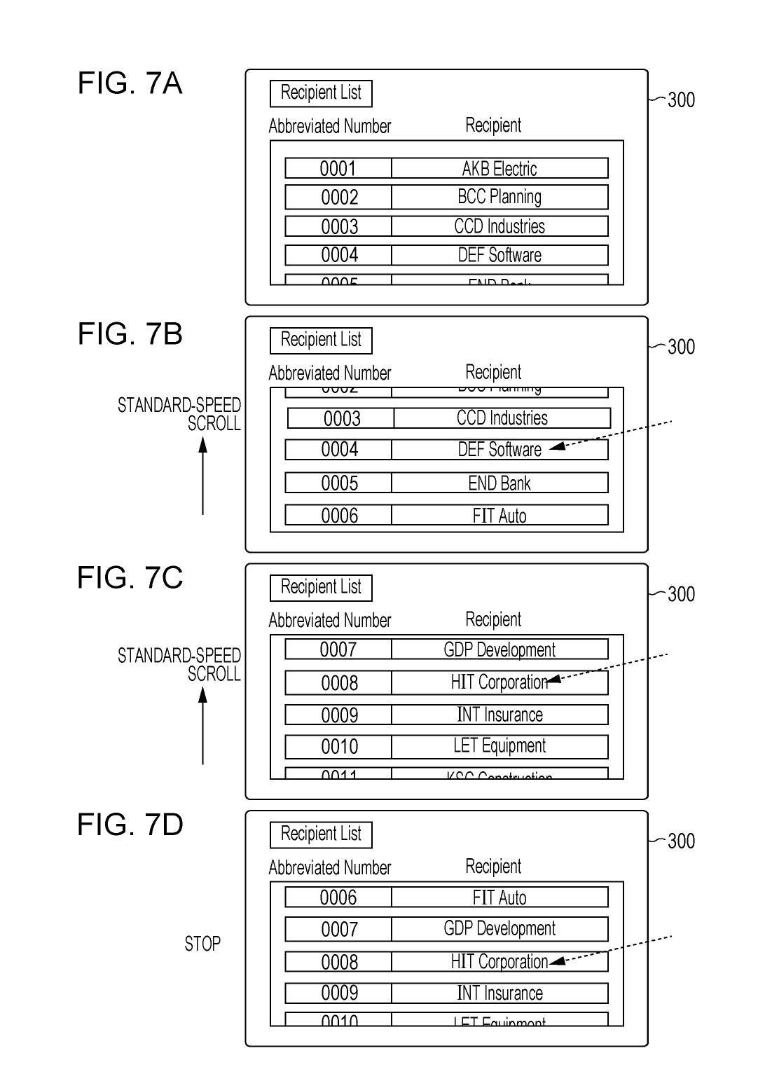

FIG. 6 is a flowchart illustrating the first example of the operations of the control device 400. FIGS. 7A to 7D illustrate examples of display images displayed in the user interface 300. In FIGS. 7A to 7D, solid arrows indicate scrolling directions and dotted arrows indicate the line of sight of the user.

First, the display item determination unit 401 determines the items to be displayed in the user interface 300 (step S101).

At this time, the display image of, for example, FIG. 7A is displayed in the user interface 300. Here, what is illustrated in FIG. 7A is similar to or the same as what is illustrated in FIG. 4.

Next, the instruction operation determination unit 402 determines whether or not the user interface 300 has accepted the movement instruction operation from the user (step S102).

If the user interface 300 has not been accepted the movement instruction operation (“NO” in step S102), processing returns to step S101. In contrast, if the user interface 300 has accepted the movement instruction operation (“YES” in step S102), the movement speed determination unit 403 selects a standard speed (first speed) and sets the standard speed as the movement speed (step S103). The display control unit 405 performs control so as to cause the items to be sequentially displayed by the user interface 300 while causing the display image to move by scrolling at the standard speed (first speed) (step S104).

At this time, the display image of FIG. 7B being moved by scrolling is displayed in the user interface 300.

While the display image is being moved by scrolling, the instruction operation determination unit 402 determines whether or not the user interface 300 has accepted the stop instruction operation as the movement instruction operation from the user (step S105).

If the user interface 300 has accepted the stop instruction operation (“YES” in step S105), the display control unit 405 performs control for stopping the movement by scrolling (step S106).

In contrast, if the user interface 300 has not been accepted the stop instruction operation (“NO” in step S105), the processing advances to the next step, that is, step S107.

Next, the line-of-sight determination unit 404 obtains information about the line of sight of the user detected by the detection device 500 (step S107). Furthermore, the line-of-sight determination unit 404 determines the position watched by the user (step S108).

Furthermore, the line-of-sight determination unit 404 determines whether or not the user watches the user interface 300, and further, whether or not this line of sight of the user has been changed (step S109). Here, the change in the line of sight is not limited to a change in the position watched by the user. For example, an enlargement of the pupil, a sudden change of the eyepoint, intensive watching, and the like may be processed as the change in the line of sight.

If the line of sight of the user toward the user interface 300 has not been changed (“NO” in step S109), the processing returns to step S105.

In contrast, if the line of sight of the user toward the user interface 300 has been changed (“YES” in step S109), the display control unit 405 performs control for positioning the item corresponding to the line of sight of the user (the item watched by the user) at a position of a central portion in the scrolling direction of the user interface 300 (in this case, the up-down direction of FIGS. 7A to 7D) and for stopping the movement by scrolling (step S110).

Assuming that the line of sight of the user changes in the display image of FIG. 7C, and the user watches the item of “HIT Corporation” indicated by the head of the dotted arrow. In this case, in the user interface 300 as illustrated in FIG. 7D, the item corresponding to the line of sight of the user (the item “HIT Corporation” watched by the user) is returned so as to be positioned in the central portion in the up-down direction of FIGS. 7A to 7D, and the scrolling is stopped.

Furthermore, after the movement of the display image has been stopped, the instruction operation determination unit 402 determines whether or not the user interface 300 has further accepted the movement instruction operation from the user (step S111).

If the user interface 300 has not been accepted the movement instruction operation (“NO” in step S111), the processing ends.

In contrast, if the user interface 300 has further accepted the movement instruction operation from the user (“YES” in step S111), the movement speed determination unit 403 selects a high speed (second speed) that is higher than the standard speed (first speed) and sets the high speed as the movement speed (step S112). The display control unit 405 performs control for a movement at the high speed (second speed) that is higher than the standard speed (first speed) to the display image having been displayed when the line of sight of the user toward the display image changed (step S113). After scrolling to the display image displayed when the line of sight of the user changed, the processing returns to step S103. That is, the display control unit 405 continues to cause the display image to move by scrolling with the movement speed returned to the standard speed (first speed).

According to the first example, the control device 400 performs control for reducing (in this case, stopping) the movement speed to a speed lower than the standard speed (first speed) when the line of sight of the user toward the display image changes while causing the display image to move. With this control, while the display image is being moved by scrolling, the display image is stopped at a position of an item of interest to the user. Thus, the user may easily find his or her target item. Furthermore, when the items that are displayed while the display image is stopped do not include the item that the user tries to find, the movement by scrolling is able to be restarted by performing again the movement instruction operation by the user. At this time, the movement to the display image displayed when the line of sight of the user changed is performed at the high speed (second speed). This may reduce time taken for the user to find the target item.

### Second Example

Next, a second example of operations of the control device 400 is described.

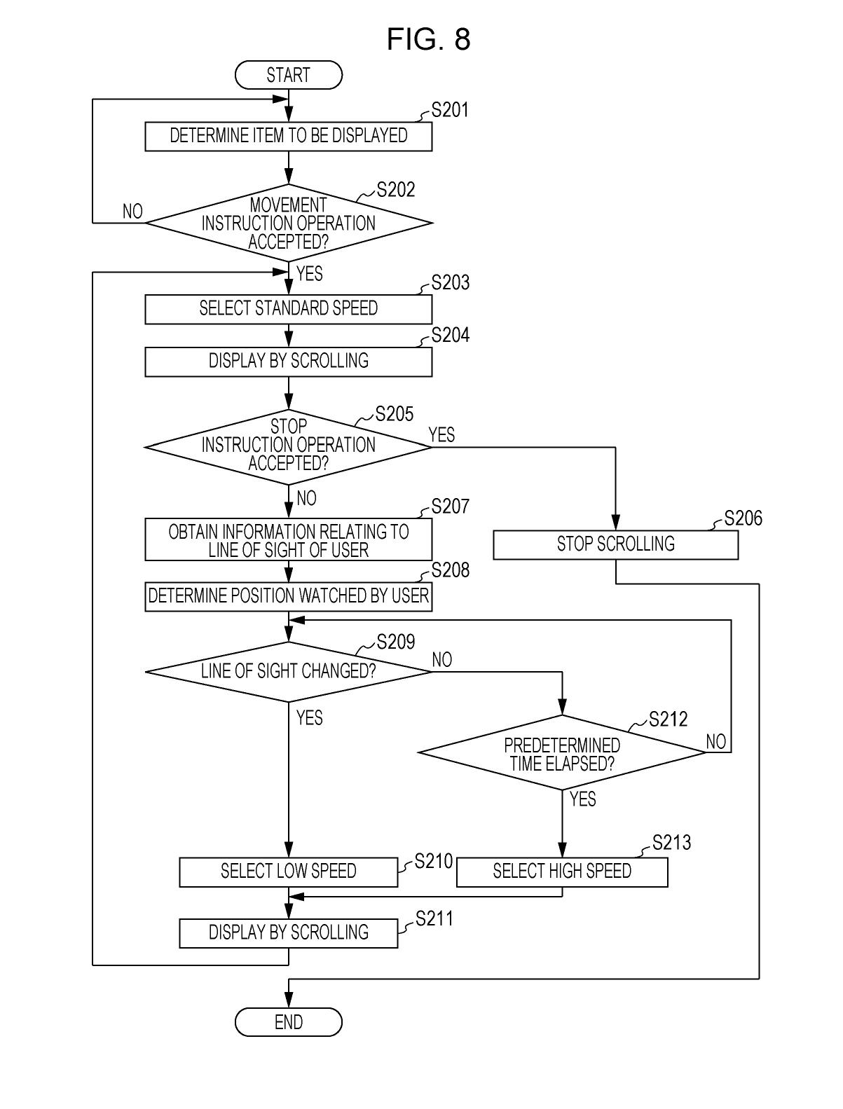

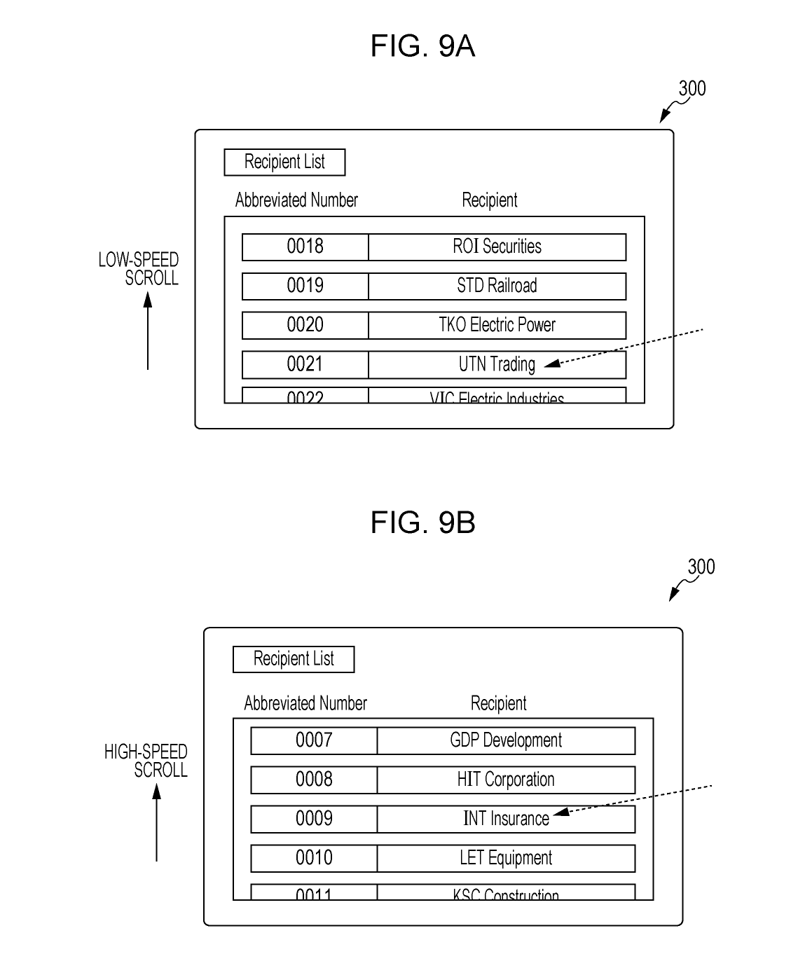

FIG. 8 is a flowchart illustrating the second example of the operations of the control device 400. FIGS. 9A and 9B illustrate examples of display images displayed in the user interface 300. In FIGS. 9A and 9B, solid arrows indicate scrolling directions and dotted arrows indicate the line of sight of the user.

Processing from step S201 to step S209 of FIG. 8 is the same as or similar to the processing from step S101 to step S109. Thus, description of the processing from step S201 to step S209 is omitted.

In step S209, if the line of sight of the user toward the user interface 300 has changed (“YES” in step S209), the movement speed determination unit 403 selects a low speed (third speed) that is lower than the standard speed (first speed) and sets the lower speed as the movement speed (step S210). The display control unit 405 performs control so as to cause the items to be sequentially displayed by the user interface 300 while causing the display image to be moved by scrolling at the standard speed (third speed) (step S211).

At this time, the display image of FIG. 9A being moved by low-speed scrolling is displayed in the user interface 300.

In contrast, if the line of sight of the user toward the user interface 300 does not change in step S209 (“NO” in step S209), the line-of-sight determination unit 404 determines whether or not a predetermined time period has elapsed while the line of sight of the user has not changed (step S212).

If the predetermined time period has not elapsed (“NO” in step S212), the processing returns to step S209. In contrast, if the predetermined time period has elapsed (“YES” in step S212), the movement speed determination unit 403 selects a high speed (fourth speed) that is higher than the standard speed (first speed) and sets this high speed as the movement speed (step S213). The display control unit 405 performs control so as to cause the items to be sequentially displayed by the user interface 300 while causing the display image to be moved by scrolling at the high speed (fourth speed) (step S211). After that, the processing returns to step S205.

At this time, the display image of FIG. 9B being moved by high-speed scrolling is displayed in the user interface 300.

According to the second example, the control device 400 causes the movement speed to change depending on whether or not the line of sight of the user toward the display image changes while the control device 400 causes the display image to move.

For example, in order to move the display image by scrolling to the item existing in a latter portion of the list, the user is not interested in a former portion of the list and starts to be careful so as to find his or her target item as the display approaches the latter portion. At this time, the line of sight of the user does not change in the former portion and changes in the latter portion due to a change of the position watched by the user in the user interface 300.

At this time, in the former portion of the list, the line of sight of the user toward the user interface 300 has not changed for the predetermined time period. In this case, the control device 400 causes the higher speed (fourth speed) that is higher than the standard speed (first speed) to be set as the movement speed. This may reduce time taken for the user to find the target item.

In contrast, in the latter portion of the list, the line of sight of the user toward the display image changes while the display image is being moved. In this case, the control device 400 performs control for reducing the movement speed to a lower speed (in this case, to the third speed) that is lower than the standard speed (first speed). With this control, while the display image is being moved by scrolling, the display image is moved at a lower speed at a position of an item of interest to the user. Thus, the user may easily find his or her target item.

Although the information processing apparatus is exemplified by the image forming apparatus 1 in the above-described examples, this is not limiting. That is, the present exemplary embodiment is applicable to any of apparatuses as long as the apparatuses display information including plural items as a display image, and the display image is moved by scrolling. For example, the present exemplary embodiment is applicable to devices such as mobile phones, smart phones, and tablets that display a phonebook including names, telephone numbers, e-mail addresses, and so forth as items and devices such as PCs on which spreadsheet software that displays spread sheets operates.

Furthermore, in the above-described examples, the information processing system S is configured by providing the detection device 500 and the image forming apparatus 1 as the information processing apparatus as separate units. However, for example, the detection device 500 may be disposed in the image forming apparatus 1 so as to be integrated with the image forming apparatus 1.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a display that displays in a form of a display image a portion of information including a plurality of items and that moves the display image at a first speed by scrolling so as to display the plurality of items in a predetermined order;
an operating unit that accepts a movement instruction operation from a user for moving the display image; and
a movement controller that performs control for reducing a movement speed to a speed lower than the first speed when a line of sight of the user toward the display image changes while the movement controller causes the display image to move.

2. The information processing apparatus according to claim 1,
wherein, when the line of sight of the user toward the display image changes, the movement controller causes an item out of the plurality of items corresponding to the line of sight of the user to be positioned in a central portion in a movement direction of the display image and causes the movement of the display image to stop.

3. The information processing apparatus according to claim 2,
wherein, in a case where the operating unit further accepts the movement instruction operation from the user after the movement of the display image has stopped, the movement controller causes the display image to move at a second speed which is higher than the first speed so as to display a portion of the display image displayed when the line of sight of the user toward the display image changed.

4. The information processing apparatus according to claim 1,
wherein, when the line of sight of the user toward the display image changes while the movement controller causes the display image to move, the movement controller performs control for continuing the movement of the display image at a third speed which is lower than the first speed.

5. The information processing apparatus according to claim 1,
wherein, when the line of sight of the user toward the display image does not change while the movement controller causes the display image to move, the movement controller performs control for moving the display image at a fourth speed which is higher than the first speed.

6. An information processing apparatus comprising:
a display that displays one or some of a plurality of items;
an operating unit that accepts an operation for transitioning what is displayed as the one or some of the plurality of items; and
a movement controller that performs control for, when a change in a line of sight of an operator toward the plurality of items is detected during the transitioning, stopping the transitioning.

7. An information processing system comprising:
a detector that detects a line of sight of a user;
a display that displays in a form of a display image a portion of information including a plurality of items and that moves the display image at a first speed by scrolling so as to display the items in a predetermined order;
an operating unit that accepts a movement instruction operation from the user for moving the display image; and
a movement controller that performs control for reducing a movement speed to a speed lower than the first speed when the detector detects a change in the line of sight of the user toward the display image while the movement controller causes the display image to move.

8. An image forming apparatus comprising:
an image forming section that forms an image on a recording material;
a display that displays in a form of a display image a portion of information about the image forming apparatus including a plurality of items and that moves the display image at a first speed by scrolling so as to display the plurality of items in a predetermined order;
an operating unit that accepts a movement instruction operation from a user for moving the display image; and
a movement controller that performs control for reducing a movement speed to a speed lower than the first speed when a line of sight of the user toward the display image changes while the movement controller causes the display image to move.
